(19) United States
(12) Patent Application Publication
(10) Pub. No.: US 2006/0174449 A1
(43) Pub. Date: Aug. 10, 2006

(54) Forearm handle for disabled

(76) Inventor: Ronnie L. Hughes, Winchester, KY (US)

Correspondence Address: LITMAN LAW OFFICES, LTD, PO BOX 15035, CRYSTAL CITY STATION, ARLINGTON, VA, 22215, US

(21) Appl. No.: 11/337,551

(22) Filed: Jan. 24, 2006

Related U.S. Application Data
(60) Provisional application No. 60/645,730, filed on Jan. 24, 2005.

(51) Int. Cl. B25G 1/10

(52) U.S. Cl. 16/430; 16/110.1; 16/422

(57) ABSTRACT

The forearm handle for the disabled is a device that allows a user to do many tasks with one arm that normally require two arms, such as raking, sweeping, or shoveling, while at the same time greatly reducing the stress placed on the wrist. The forearm handle is a frame that fits over either the right or left forearm of a user. The frame has two brackets extending along the sides of a user's forearm. At the elbow end of the frame the brackets are connected by a first pivoting U-shaped member. At the hand end of the frame the brackets are connected by a D-shaped handle having a grip and a socket. A second pivoting U-shaped member, an elastic strap, and a hook and loop fastener strap are further placed between the brackets to provide additional support. The socket on the D-shaped handle is adapted for the attachment of brooms, sporting accessories, a crutch, or the like.

### CROSS-REFERENCE TO RELATED APPLICATION

This application claims the benefit of U.S. Provisional Patent Application Ser. No. 60/645,730, filed Jan. 24, 2005.

### BACKGROUND OF THE INVENTION

1. Field of the Invention

The present invention relates to a handle, and more particularly to a handle that can be used with multiple attachments and that secures to a person's forearm in order to facilitate the use of the attachments.

2. Description of the Related Art

A total of twenty-seven bones, joints and soft tissues such as muscles, ligaments and tendons make up a person's hand and wrist. Because the hand and wrist are anatomically complex, they are both subject to numerous types of injuries and degenerative disorders. Some of the disorders that a person may experience to their hands and wrists include strains, arthritis, contusions, tendonitis, cumulative trauma disorder (CDT) of the wrist and carpal tunnel syndrome (CTS). Some of these disorders, such as tendonitis and CTS, are the result of repetitive hand, finger or wrist movement.

Injuries or degenerative disorders affecting the hands or wrists, including the loss of a hand, can make the use of tools with long handles, such as brooms, rakes and shovels, difficult, painful, or even impossible. The difficulties may arise from loss of grip strength, loss of manual dexterity, or pain. In fact, the continued or repetitive use of long-handled tools may cause injuries, such as tendonitis and CTS, to a person's hands and wrists because the lever action of a tool having an elongated handle increases the strain on a user's wrists. Many long-handled tools are designed for a person with two serviceable arms, and much of the force and motion imparted to the tool is delivered by the motion of the wrist. Similarly, a person who has lost a hand has great difficulty in using long-handled implements.

Several devices have been proposed for improved implements that reduce the strain on a person's wrists when using certain kinds of hand tools. Many of these devices involve a brace that encompasses the forearm to distribute the weight of the hand tool more evenly. Typically, the brace is connected directly to the tool or to a coupling device that is employed so that multiple tools may be used with the same brace. Most of the solutions put forward have been inadequate because of discomfort to the user, difficulty in putting the brace on initially, and ineffective distribution of stresses. Thus, a forearm handle for the disabled solving the aforementioned problems is desired.

### SUMMARY OF THE INVENTION

The forearm handle for the disabled is a device that fits over the forearm of a user and allows the user to do many tasks with one arm that normally require two arms, such as raking, sweeping, or shoveling, while at the same time greatly reducing the stress placed on the wrist. The forearm handle is a frame that fits over the forearm of a user from just below the elbow to below the hand. The frame has two brackets running along the sides of a user's forearm. At the elbow end of the frame the brackets are connected by a first pivoting U-shaped member. At the hand end of the frame the brackets are connected by a D-shaped handle having a grip and a socket. A second pivoting U-shaped member is placed between the brackets approximately at the position of a user's wrist. Also extending between the brackets are an elastic strap placed between the first and second U-shaped members, and a hook and loop fastener strap placed between the second U-shaped member and the D-shaped handle. The socket on the D-shaped handle is for the attachment of brooms, mops, shovels, sporting accessories, a crutch, or the like. Any implement that may be fitted with a handle for attachment to a socket may be used with the forearm handle.

The frame of the forearm handle is generally contoured to match the shape of a user's forearm so that the same forearm handle may be worn on either a user's left or right arm. The frame is of molded construction. The U-shaped members may be padded to ensure maximum comfort of the user. The U-shaped members are pivoting so that the forearm handle may be worn either palm up or palm down, according to the needs of the user. The elastic strap and the hook and loop strap secure the forearm handle to the user. Both the hook and loop strap and the elastic strap may be adjusted by the user with his or her teeth. The grip of the D-shaped handle may be replaced by a cup so that the forearm handle can be used by a person who is missing a hand.

These and other features of the present invention will become readily apparent upon further review of the following specification and drawings.

### BRIEF DESCRIPTION OF THE DRAWINGS

FIG. 1 is a perspective view of a forearm handle for the disabled according to the present invention.

FIG. 2 is an environmental perspective view of a forearm handle for the disabled with an arm inserted palm down.

FIG. 3 is an environmental perspective view of a forearm handle for the disabled with an arm inserted palm up.

FIG. 4 is an environmental perspective view of a forearm handle for the disabled with a cup attachment for person's missing a hand.

FIG. 5 is a perspective view of a forearm handle for the disabled with a broom attachment.

FIG. 6 is a perspective view of a forearm handle for the disabled with a rake attachment.

FIG. 7 is a perspective view of a forearm handle for the disabled with a crutch attachment.

FIG. 8 is a close up view of the bottom of the crutch attachment of FIG. 7.

Similar reference characters denote corresponding features consistently throughout the attached drawings.

### DETAILED DESCRIPTION OF THE PREFERRED EMBODIMENTS

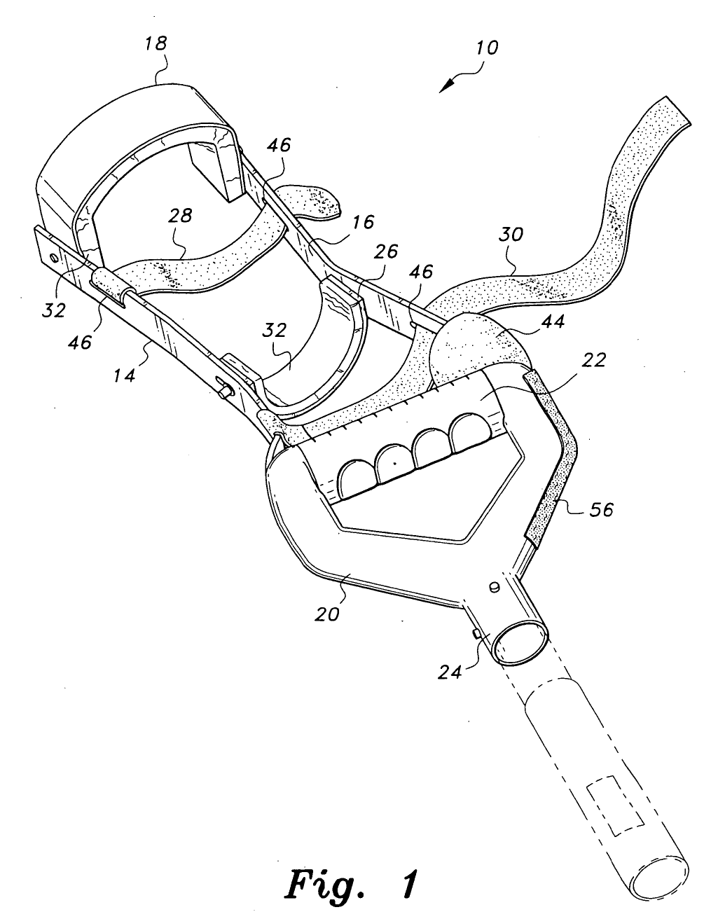

The present invention is a forearm handle for the disabled, designated generally as 10 in the drawings and referred to as the “forearm handle.” Referring to FIGS. 1-3, the forearm handle 10 is designed to receive attachments that allow a user afflicted with a handicap in their arm, wrist, or hand to do many tasks with one arm that normally require the use of two arms, while at the time removing the stress from the wrist and distributing the stress across the forearm. The forearm handle 10 is further designed to be used by persons who have lost a hand, or by people who suffer no handicaps that still wish to relieve the strain on their joints caused by the use of long-handled or pole tools, such as mops, brooms, and shovels.

The forearm handle 10 is shaped like a frame or brace that fits over the forearm of a user from just below the elbow to below the hand. The forearm handle 10 has two brackets 14, 16 extending along opposing sides of a user's forearm 34. The brackets 14, 16 are contoured generally to match the shape of a person's forearm 34. It is contemplated that the forearm handle 10 may come in a variety of sizes and the same forearm handle 10 may be worn on either a user's left or right arm. At the elbow end of the forearm handle 10 the brackets 14, 16 are connected by a first pivoting U-shaped member 18. At the hand end, the brackets 14, 16 are connected by a D-shaped handle 20 having a grip 22 and a socket 24. A second pivoting U-shaped member 26 is placed between the brackets 14, 16 approximately at the position of a user's wrist adjacent the hand end of the brackets 14, 16. Also extending between the brackets 14, 16 is an elastic strap 28 placed between the first and second U-shaped members 18, 26, and a hook and loop fastener strap 30 placed between the second U-shaped member 26 and the D-shaped handle 20. Both the elastic strap 28 and the hook and loop strap 30 are threaded through slots 46 formed in the brackets 14, 16 and are permanently attached at one end to bracket 14.

The socket 24 on the D-shaped handle 20 is for the attachment of brooms, mops, shovels, sporting accessories, a crutch, or any other tool or accessory having a long, pole-type handle. Any implement that may be fitted with a handle for attachment to a socket may be used with the forearm handle 10. The socket 24 may be configured with any means conventionally known for securing a shaft or pole handle within a tubular socket. For example, socket 24 may be internally threaded to received a threaded stud extending from the implement shaft; the socket 24 may be configured to received spring-biased detent pins extending laterally from the shaft; the socket 24 may be configured with a slot to receive a bayonet connector; the socket 24 may be configured with a spring-biased stop, an axial slot, and a T-shaped slot extending lateral to the axial slot for locking a pin extending laterally from the implement shaft; the socket 24 may be fitted with a chuck, similar to a Jacob chuck; the socket 24 may be fitted with a quick connect coupler similar to those used for connecting air hose to an air tool; the socket 24 may be fitted with set screws or spring-biased detent pins for engaging threaded holes or annular detent rings defined in the shaft; or the socket 24 may be fitted or configured with any other connector or coupling mechanism known in the art for attaching a shaft or pole handle to a tubular socket.

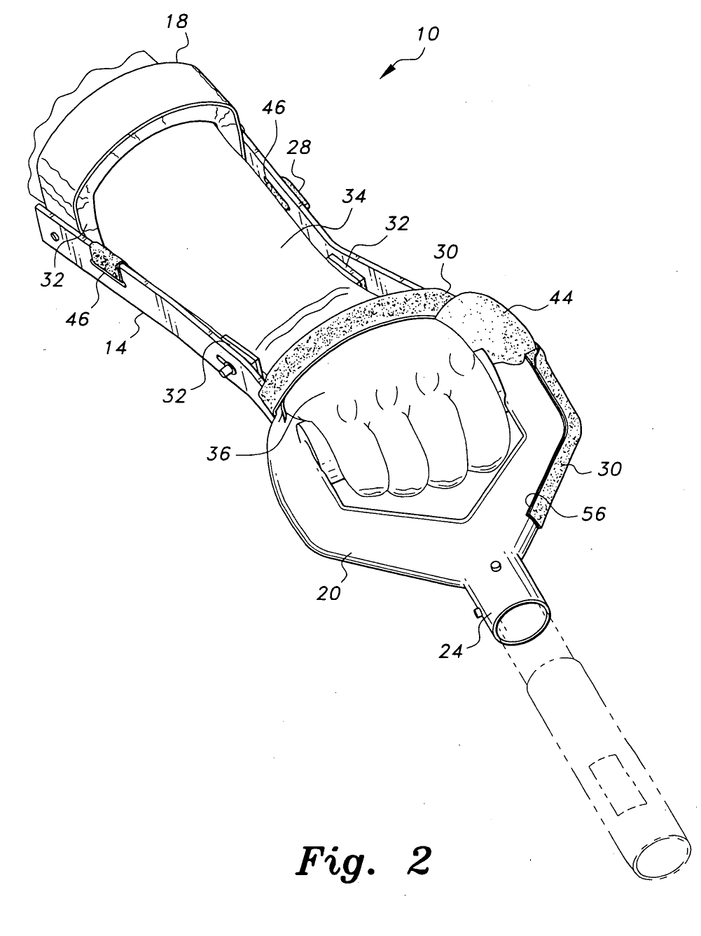

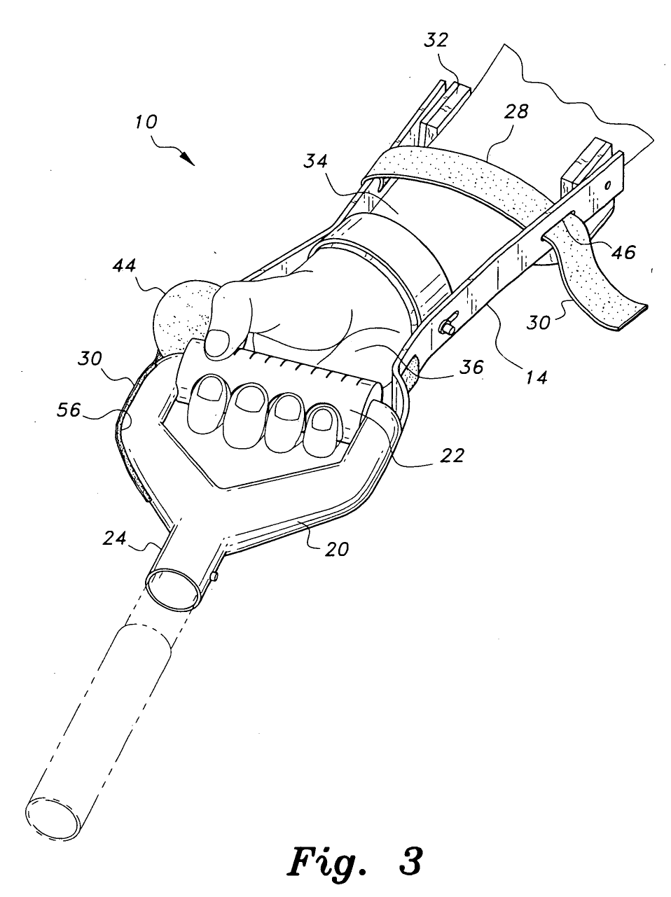

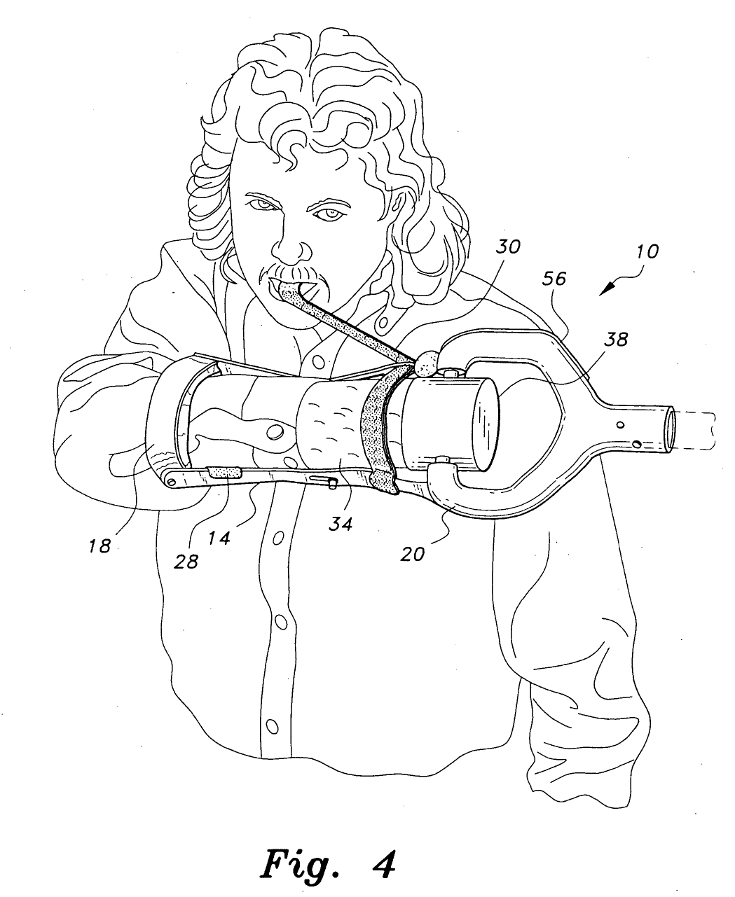

The brackets 14, 16 and the D-shaped handle 20 are of molded construction. The first and second pivoting U-shaped members 18, 26 may be equipped with cushioning pads 32 to ensure maximum comfort of the user. A foam thumb guard 44 is placed between the D-shaped handle 20 and the bracket 16 for comfort of the user. As shown in FIGS. 2 and 3, the forearm handle 10 may be used so that a user's hand 36 is either palm down, as in FIG. 2, or palm up, as in FIG. 3. Before putting on the forearm handle 10 a user rotates the first and second pivoting U-shaped members 18, 26 so that they are in opposition. For this purpose, both U-shaped members are capable of pivoting 180° between the brackets 14 and 16. It will further be noted that the U-shaped members 18, 26 extend to opposite sides of the brackets 14, 16 in order to support opposite sides of the forearm and wrist, i.e., the dorsal and ventral sides of the forearm and wrist. The user then inserts his or her hand 36 and forearm 34 into the forearm handle 10. The first pivoting U-shaped member 18 and the elastic strap 28 form a cuff that encircles the upper part of the forearm 34. Similarly, the second pivoting U-shaped member 26 and the hook and loop strap 30 form a cuff that encircles the lower part of the forearm 34 near the wrist. Referring to FIG. 4, the hook and loop strap 30 may be secured by a user using his or her teeth. Similarly, the tightness of the elastic strap 28 may be adjusted by a user using his or her teeth. It is common for those suffering a handicap to their arms or hands to have to rely on their teeth and the forearm handle 10 is thus designed. The hook and loop strap 30 is the hook portion of a hook and loop fastening system. The mating loop portion 56 is fixed to, and extends along, the outer side of the bracket 16.

Referring again to FIG. 4, the grip 22 of the D-shaped handle 20 may be replaced by a cup 38 adapted to receive a stump so that the forearm handle 10 can be comfortably used by a person who is missing a hand. It is contemplated that the grip 22 and the cup 38 are removably attached to the D-shaped handle 20 so that one forearm handle 10 may be manufactured for a variety of users.

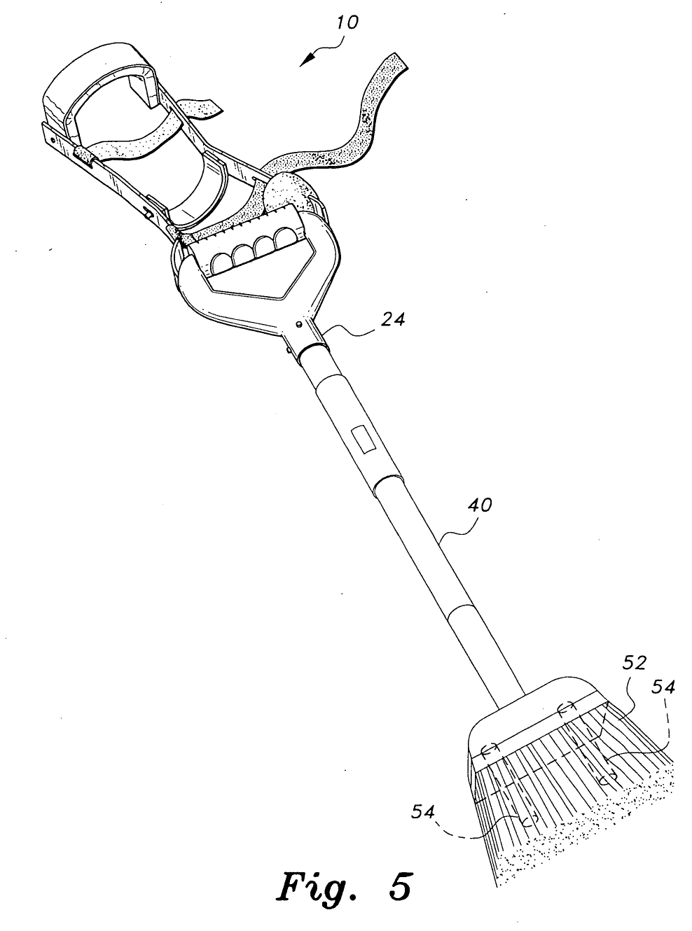

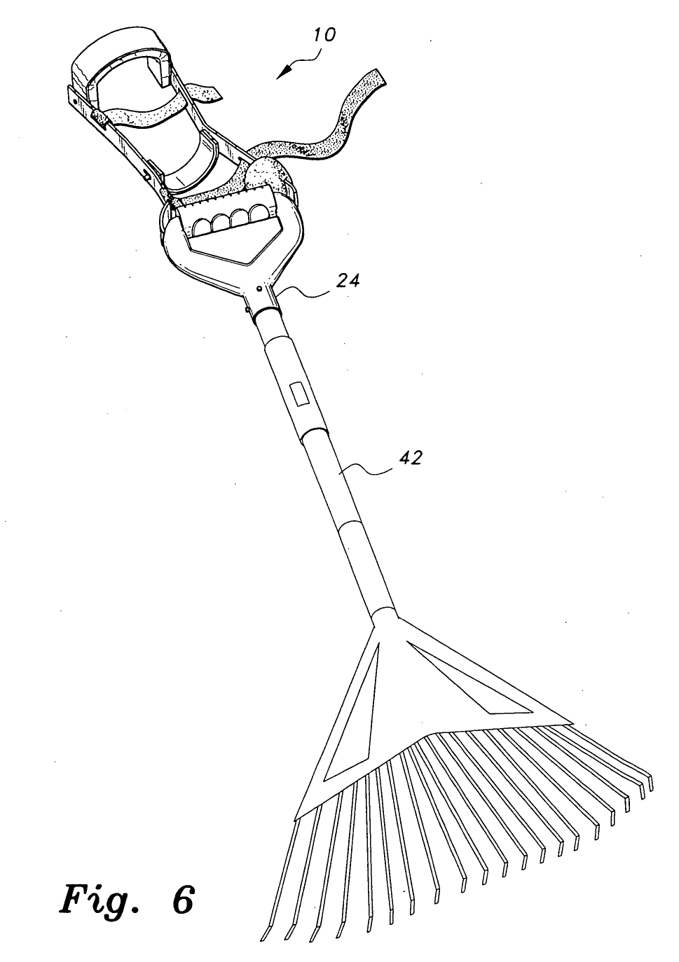

As shown in FIGS. 5-7, a variety of attachments are contemplated for use with the forearm handle 10. FIG. 5 shows an integrated crutch/broom attachment 40 fit in to the socket 24. The integrated crutch/broom attachment 40 features bristles 52 for sweeping and a pair of solid rods 54 for a resting upon a supporting surface when the bristles 52 are not in use. FIG. 6 shows a rake attachment 42. Several commercially available socket systems featuring tubular interlocking members are compatible with the design of the forearm handle 10. In addition to long-handled tools, such as those shown in FIGS. 5 and 6, other implements, such as paddles, golf clubs, rifles, and any accessory requiring wrist support, may be used with the present invention.

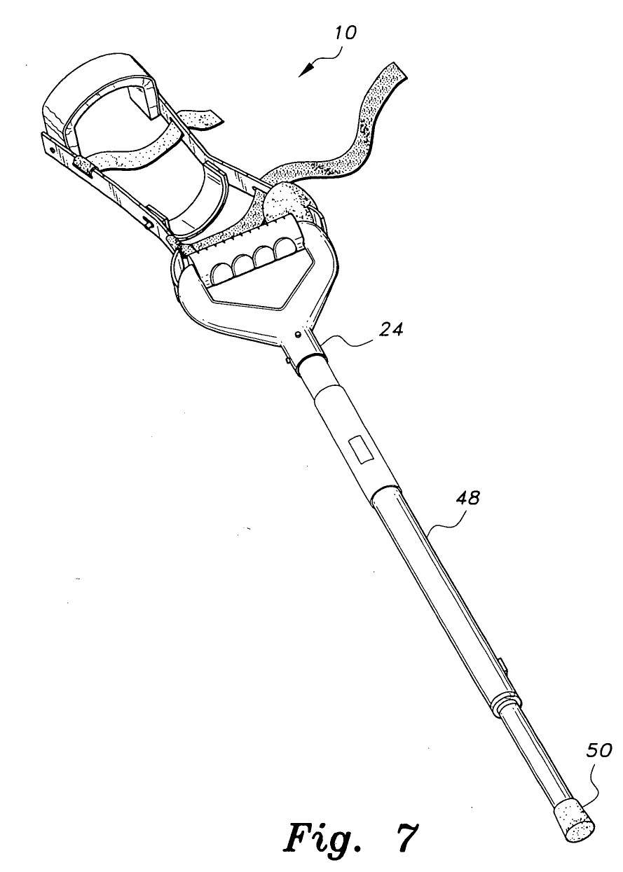

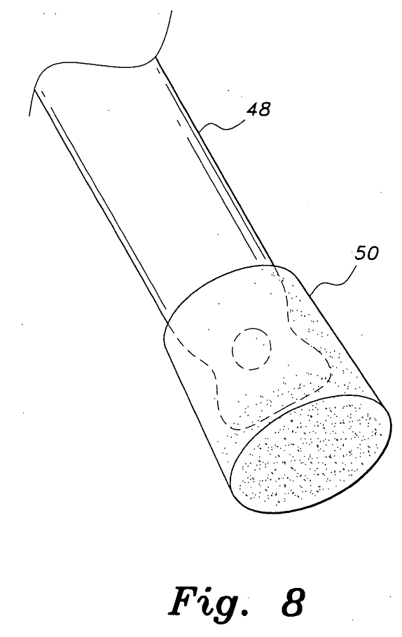

The ergonomic design of the forearm handle 10 makes it possible to use a crutch attachment 48, as shown in FIG. 7. Most conventional crutches are placed underneath a person's armpit, while a cane is supported by a user's wrist. Conventional canes and crutches have a tip formed by a rubber-tipped boot that has a tendency to stick to the ground and hinder the movement of a person using it. To further facilitate the use of a crutch attachment 48, it is contemplated that a rolling crutch tip 50, as shown in FIG. 8, be used with the crutch attachment 48.

Thus, it will be seen that the forearm handle 10 of the present invention provides great assistance to those suffering from loss of a hand or from loss of use of a hand.

It is to be understood that the present invention is not limited to the embodiments described above, but encompasses any and all embodiments within the scope of the following claims.

I claim:

1. A forearm handle for disabled persons, comprising:
a first bracket and a second bracket adapted for being placed on opposing sides of a forearm, each bracket having an elbow end and a hand end;
a first U-shaped member pivotally attached between the elbow ends of the first bracket and the second bracket;
a D-shaped handle extending between the hand ends of the first and second brackets, the D-shaped handle having a removable grip and a socket extending opposite hand ends of the brackets, the socket being adapted to receive a pole-handled attachment; and
at least one flexible strap intermediately placed between the first bracket and the second bracket.

2. The forearm handle according to claim 1, wherein said first U-shaped member is pivotal over a range of 180°.

3. The forearm handle according to claim 1, further comprising a second U-shaped member pivotally attached between said first bracket and said second bracket adjacent the hand ends of said brackets.

4. The forearm handle according to claim 3, wherein said first and second U-shaped members pivot to opposite sides of said brackets in order to support opposite sides of the forearm and wrist.

5. The forearm handle according to claim 3, wherein said second U-shaped member is pivotal over a range of 180°.

6. The forearm handle according to claim 3, wherein one of said brackets has a first hook and loop fastener attached thereto disposed between said second U-shaped member and said D-shaped handle, said at least one flexible strap having a first end fixed to one of said brackets and a second end forming a second hook and loop fastener mating with the first hook and loop fastener for forming a loop around the wrist in combination with the second U-shaped member and continuously adjusting the diameter of the loop.

7. The forearm handle according to claim 3, wherein said second U-shaped member further comprises a cushioning pad attached thereto.

8. The forearm handle according to claim 3, wherein one of said brackets has a first slot defined therein adjacent the elbow ends of said brackets and a first hook and loop fastener adjacent the hand ends of said brackets, said at least one flexible strap comprising:
a first strap having a first end fixed to one of the brackets and a second end extending through the first slot, said first strap being formed from an elastic material and forming a loop in combination with said first U-shaped member adapted for encircling the forearm adjacent the elbow; and
a second strap having a first end fixed to one of the brackets and a second end forming a second hook and loop fastener mating with the first hook and loop fastener in order to form a loop in combination with said second U-shaped fastener adapted for encircling the forearm adjacent the wrist.

9. The forearm handle according to claim 1, wherein said at least one flexible strap comprises an elastic strap disposed adjacent the elbow ends of said brackets, said elastic strap forming a loop in combination with said first U-shaped member adapted for securing said brackets to the forearm.

10. The forearm handle according to claim 1, further comprising a foam thumb guard disposed between said grip and one of said brackets.

11. The forearm handle according to claim 1, further comprising a cup adapted for receiving a stump of a hand amputee, said cup being removably interchangeable with said grip.

12. The forearm handle according to claim 1, further comprising a combination broom and crutch having a pole handle attachable to said socket and a head attached to the pole handle, the head having bristles extending therefrom and at least one crutch tip extending between the bristles.

13. The forearm handle according to claim 1, further comprising a crutch implement having a pole end attachable to said socket and an opposite crutch end having a rubber tip and a crutch socket disposed in the rubber tip, the crutch socket being pivotally attached to the crutch end within the rubber tip.
